(19) United States
(12) Patent Application Publication
(10) Pub. No.: US 2015/0340013 A1
(43) Pub. Date: Nov. 26, 2015

(54) WIRELESS COMMUNICATION APPARATUS AND METHOD OF DRIVING DISPLAY DEVICE INCLUDED IN WIRELESS COMMUNICATION APPARATUS

(71) Applicant: Samsung Display Co., Ltd., Yongin-city (KR)

(72) Inventors: Ki-Seob LEE, Seongnam-si (KR); Jeong-Mo NAM, Incheon (KR); Se-Hwan AN, Goyang-si (KR); Jung-Mi YUN, Daegu (KR)

(21) Appl. No.: 14/570,538

(22) Filed: Dec. 15, 2014

(30) Foreign Application Priority Data
May 21, 2014 (KR) 10-2014-0060966

(51) Int. Cl. G09G 5/18; G09G 5/00

(52) U.S. Cl. CPC G09G 5/18; G09G 5/003; G09G 2370/16

(57) ABSTRACT

A wireless communication apparatus and method of driving a display device included in the wireless communication apparatus are disclosed. In one aspect, the method includes sequentially changing a clock control value to a plurality of predetermined set values. The clock control value is stored in a memory and is configured to control a driving clock signal of the display device. The method further includes measuring a plurality of reception sensitivities of the wireless communication apparatus with respect to each of the set values and determining an optimal set value of the set values corresponding to a present wireless communication condition based on the measured reception sensitivities. The method also includes storing the optimal set value in the memory as the clock control value.

### INCORPORATION BY REFERENCE TO ANY PRIORITY APPLICATIONS

This application claims priority under 35 U.S.C. §119 to Korean Patent Application No. 10-2014-0060966 filed on May 21, 2014, the disclosure of which is hereby incorporated by reference herein in its entirety.

### BACKGROUND

1. Field

The described technology generally relates to a display device, and more particularly, to a wireless communication apparatus and a method of driving a display device included in the wireless communication apparatus.

2. Description of the Related Technology

As the performance of wireless communication apparatuses such as mobile devices improves, reception sensitivity, for example, total isotropic sensitivity (TIS), becomes more important. There are various problems in improving radio frequency (RF) noise due to the diversity of communication standards in use, the increase of operational speeds and bandwidth, etc., and accordingly noise optimization design is becoming an important design consideration. Unexpected noises and mismatch to various standards may lengthen development time and hinder mass production.

The standard mobile device includes broadband antennas located near a display panel to support various wireless communication standards. The display panel which can be a liquid crystal display (LCD) panel, an organic light-emitting diode (OLED) display panel, etc. is a critical source of noise. The RF noise generated by the display panel flows into the antennas, degrading the reception sensitivity of the mobile device.

### SUMMARY OF CERTAIN INVENTIVE ASPECTS

One inventive aspect is a method of driving a display device, capable of reducing noise and improving reception sensitivity by adaptively reflecting changes in wireless communication conditions.

Another aspect is a wireless communication apparatus adopting the method of driving a display device, capable of reducing noise and enhancing reception sensitivity by adaptively reflecting changes in wireless communication conditions.

Another aspect is a method of driving a display device included in a wireless communication apparatus including sequentially changing a clock control value to set values, where the clock control value is stored in a storing unit to control a driving clock signal of the display device. Reception sensitivities of the wireless communication apparatus are measured with respect to each of the set values. An optimal set value corresponding to a present wireless communication condition is determined among the set values based on the measured reception sensitivities. The optimal set value is stored in the storing unit as the clock control value.

The clock control value may include a first control value to control a frequency of the driving clock signal and a second control value to control a spread spectrum modulation of the driving clock signal.

The first control value may include at least one division rate provided to a phase-locked loop configured to generate the driving clock signal.

The second control value may include a flag value indicating whether to perform the spread spectrum modulation.

The second control value may further include at least one of a modulation rate and a modulation frequency of the spread spectrum modulation.

Sequentially changing the clock control value to the set values may include receiving each of the set values from a processor included in the wireless communication apparatus and storing the received set value in the storing unit to replace the clock control value stored in the storing unit.

The storing unit may be implemented with an electrically erasable and programmable read only memory (EEPROM).

A frequency of the driving clock signal may be sequentially changed to set frequencies, the reception sensitivities may be measured with respect to each of the set frequencies without performing the spread spectrum modulation, and an optimal frequency corresponding to the present wireless communication condition may be determined among the set frequencies based on the measured reception sensitivities.

The reception sensitivity corresponding to the optimal frequency may be measured while performing the spread spectrum modulation, the reception sensitivity corresponding to the optimal frequency measured without performing the spread spectrum modulation may be compared with the reception sensitivity corresponding to the optimal frequency measured while performing the spread spectrum modulation, and whether to perform the spread spectrum modulation may be determined based on the comparison result.

In further example embodiments, when it is determined to perform the spread spectrum modulation, at least one of a modulation rate and a modulation frequency of the spread spectrum modulation corresponding to the present wireless communication condition may be determined.

A frequency of the driving clock signal may be sequentially changed to set frequencies, the reception sensitivities may be measured with respect to each of the set frequencies without performing the spread spectrum modulation and the reception sensitivities may be measured with respect to each of the set frequencies while performing the spread spectrum modulation.

An optimal frequency corresponding to the present wireless communication condition may be determined among the set frequencies and whether to perform the spread spectrum modulation may be determined, based on the measured reception sensitivities.

In further example embodiments, the reception sensitivity of the wireless communication apparatus may be monitored in real-time, and whether to update the clock control value stored in the storing unit may be determined based on the monitoring results.

In other example embodiments, whether to update the clock control value stored in the storing unit may be determined based on an input operation of a user of the wireless communication apparatus.

The reception sensitivity may be measured as a bit error rate of a wireless signal received by the wireless communication apparatus.

Another aspect is a wireless communication apparatus including a sensitivity detector, a display device and a processor. The sensitivity detector measures a reception sensitivity of a wireless signal. The display device operates based on a driving clock signal and stores a clock control value to control the driving clock signal. The processor sequentially provides set values to change the clock control value to the set values, receives the reception sensitivities with respect to each of the set values from the sensitivity detector, and determines an optimal set value corresponding to a present wireless communication condition among the set values based on the reception sensitivities.

The clock control value may include a first control value to control a frequency of the driving clock signal and a second control value to control a spread spectrum modulation of the driving clock signal.

The display device may include an electrically erasable and programmable read only memory (EEPROM) configured to store the clock control value, and a clock control unit configured to control the driving clock signal based on the clock control value stored in the EEPROM.

The processor may monitor the reception sensitivity of the wireless communication apparatus in real-time and determine whether to update the clock control value stored in the storing unit based on the monitoring results.

The processor may determine whether to update the clock control value stored in the storing unit based on an input operation of a user of the wireless communication apparatus.

Another aspect is a method of driving a display device included in a wireless communication apparatus, the method comprising sequentially changing a clock control value to a plurality of predetermined set values, wherein the clock control value is stored in a memory and is configured to control a driving clock signal of the display device; measuring a plurality of reception sensitivities of the wireless communication apparatus with respect to each of the set values; determining an optimal one of the set values corresponding to a present wireless communication condition based on the measured reception sensitivities; and storing the optimal set value in the memory as the clock control value.

The clock control value can include a first control value configured to control a frequency of the driving clock signal and a second control value configured to control a spread spectrum modulation of the driving clock signal. The first control value can include at least one division rate and the display device can include a phase-locked loop configured to generate the driving clock signal based on the division rate. The second control value can include a flag value indicating whether to perform the spread spectrum modulation. The second control value can further include at least one of a modulation rate and a modulation frequency of the spread spectrum modulation. Sequentially changing the clock control value can include receiving each of the set values from a processor included in the wireless communication apparatus and sequentially storing each of the received set values in the memory to replace the clock control value stored in the memory. The memory can be an electrically erasable and programmable read only memory (EEPROM).

The method can further comprise sequentially changing a frequency of the driving clock signal to a plurality of set frequencies; measuring the reception sensitivities with respect to each of the set frequencies without performing the spread spectrum modulation; and determining an optimal one of the set frequencies corresponding to the present wireless communication condition based on the measured reception sensitivities. The method can further comprise measuring the reception sensitivity corresponding to the optimal frequency while performing the spread spectrum modulation; comparing the measured reception sensitivity corresponding to the optimal frequency without performing the spread spectrum modulation to the reception sensitivity corresponding to the optimal frequency measured while performing the spread spectrum modulation; and determining whether to perform the spread spectrum modulation based on the comparison result. The method can further comprise when it is determined to perform the spread spectrum modulation, determining at least one of a modulation rate and a modulation frequency of the spread spectrum modulation corresponding to the present wireless communication condition.

The method can further comprise sequentially changing a frequency of the driving clock signal to a plurality of set frequencies; measuring the reception sensitivities with respect to each of the set frequencies without performing the spread spectrum modulation; and measuring the reception sensitivities with respect to each of the set frequencies while performing the spread spectrum modulation. The method can further comprise determining an optimal one of the set frequencies corresponding to the present wireless communication condition; and determining whether to perform the spread spectrum modulation based on the measured reception sensitivities. The method can further comprise monitoring the reception sensitivities of the wireless communication apparatus in real-time; and determining whether to update the clock control value stored in the memory based on the monitoring results. The method can further comprise determining whether to update the clock control value stored in the storing unit based on an input operation of a user of the wireless communication apparatus. The reception sensitivity can be measured as a bit error rate of a wireless signal received by the wireless communication apparatus.

Another aspect is a wireless communication apparatus comprising a sensitivity detector configured to measure a plurality of reception sensitivities of a wireless signal with respect to a plurality of set values; a display device configured to operate based on a driving clock signal and store a clock control value configured to control the driving clock signal; and a processor configured to: sequentially provide the set values to the display device so as to change the clock control value to the set values, receive the reception sensitivities from the sensitivity detector, and determine an optimal one of the set values corresponding to a present wireless communication condition based on the reception sensitivities.

The clock control value can include a first control value configured to control a frequency of the driving clock signal and a second control value configured to control a spread spectrum modulation of the driving clock signal. The display device can comprise an electrically erasable and programmable read only memory (EEPROM) configured to store the clock control value and a clock controller configured to control the driving clock signal based on the clock control value stored in the EEPROM. The processor can be further configured to monitor the reception sensitivities of the wireless communication apparatus in real-time; and determine whether to update the clock control value stored in the memory based on the monitoring results. The processor can be further configured to determine whether to update the clock control value stored in the memory based on an input operation of a user of the wireless communication apparatus.

### BRIEF DESCRIPTION OF THE DRAWINGS

FIG. 1 is a flowchart illustrating a method of driving a display device according to example embodiments.

FIG. 2 is a block diagram illustrating a wireless communication apparatus according to example embodiments.

FIG. 3 is a block diagram illustrating a display device included in the wireless communication apparatus of FIG. 2.

FIG. 4 is a block diagram illustrating a clock control unit included in the display device of FIG. 3.

FIG. 5 is a diagram illustrating an example of a clock control value stored in a storing unit included in the display device.

FIG. 6 is a diagram illustrating an example of a spread spectrum modulation.

FIGS. 7 and 8 are diagrams for describing noise spreading according to the spread spectrum modulation.

FIG. 9 is a flowchart illustrating a method of driving a display device according to an example embodiment.

FIG. 10 is a flowchart illustrating a method of driving a display device according to another example embodiment.

FIG. 11 is a block diagram illustrating a wireless communication apparatus according to example embodiments.

### DETAILED DESCRIPTION OF CERTAIN INVENTIVE EMBODIMENTS

The example embodiments are described more fully hereinafter with reference to the accompanying drawings. Like or similar reference numerals refer to like or similar elements throughout.

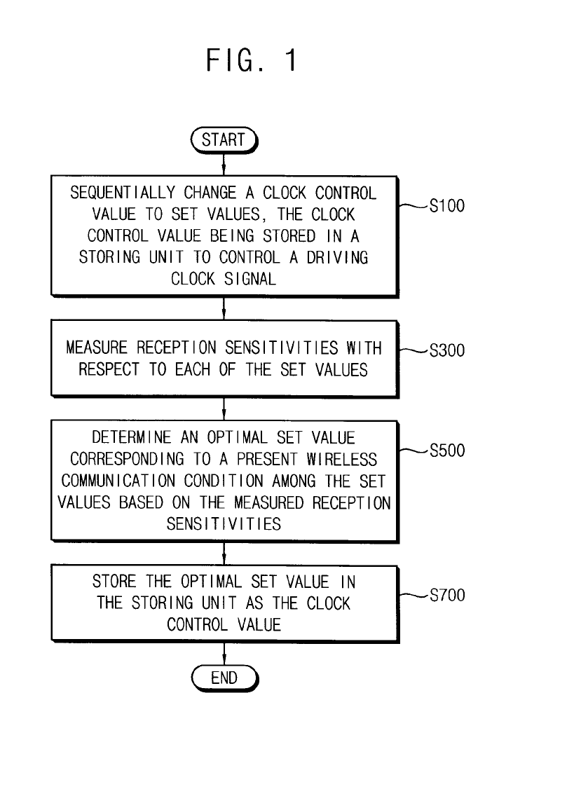

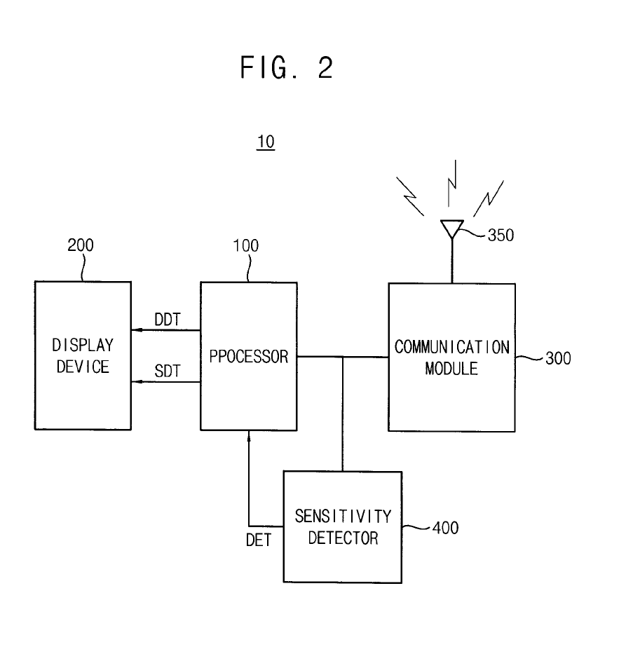

FIG. 1 is a flowchart illustrating a method of driving a display device according to example embodiments. The display device may be included in a wireless communication apparatus. The example configurations of the wireless communication apparatus and the display device are described below with reference to FIGS. 2, 3 and 4.

Referring to FIG. 1, a clock control value CCV is sequentially changed to set values (S100) and the clock control value CCV is stored in a storing unit or memory to control a driving clock signal DCK of the display device. The set values are test values that are sequentially stored in the storing unit to replace the stored clock control value CCV. The set values may be provided from a processor included in the wireless communication apparatus as described below. The reception sensitivities of the wireless communication apparatus are measured with respect to each of the set values (S300). An optimal set value corresponding to a present wireless communication condition is determined from among the set values based on the measured reception sensitivities (S500). The optimal set value is stored in the storing unit as the clock control value CCV (S700).

The wireless communication apparatus, which may be, for example, a mobile device, can operate in various communication bands depending on states, telecommunication companies, communication standards, etc. The bands include widebands or broadbands with bandwidth of about 75 MHz for the 2G/3G communication standards and bandwidth of about 90 MHz for the LTE communication standard. Such broadbands are wider than the frequency (about 60 to about 70 MHz) of the driving clock signal DCK of recently manufactured high-resolution display devices. It is difficult to determine the optimal frequency of the driving clock signal DCK that is outside of all of the major communication bands and harmonic noises of the driving clock signal DCK may cause a deep channel in which wireless communication is significantly deteriorated.

The harmonic noises can be reduced through spread spectrum clock generation (SSCG). SSCG can reduce the peak values of the harmonic noises but increases the number of channels that are affected by the harmonic noises because the frequency range of the noise is broadened. It is difficult to determine whether to perform SSCG because the overall performance of wireless communication may be degraded by SSCG.

According to example embodiments, the driving clock signal DCK can be controlled by reflecting changes in wireless communication conditions, that is, operational environments of the wireless communication apparatus that can affect the ability of the wireless communication apparatus to receive wireless signals, and thus electro-magnetic interference can be reduced and wireless communication performance can be improved.

FIG. 2 is a block diagram illustrating a wireless communication apparatus according to example embodiments.

Referring to FIG. 2, the wireless communication apparatus 10 includes a processor 100, a display device 200, a communication module 300 and a sensitivity detector 400.

The communication module 300 can receive a wireless signal through an antenna 350 and output a digital electrical signal corresponding to the received wireless signal. For example, the communication module 300 can include an RF synchronizing unit, a baseband processing unit, etc. The RF synchronizing unit can be configured to select a wireless communication channel and maintain synchronization of the selected channel. The baseband processing unit can demodulate the synchronized signal from the RF synchronizing unit to output the digital electrical signal. When quadrature amplitude modulation (QAM) is adopted, the baseband processing unit can divide the synchronized signal into an I-signal and a Q-signal to convert the two analog signals into digital signals.

The sensitivity detector 400 measures the reception sensitivity of the wireless signal based on the output of the communication module 300. The measured reception sensitivity can be provided as a detection signal DET to the processor 100. In an example embodiment, the sensitivity detector 400 measures the bit error rate of the wireless signal received by the wireless communication apparatus 10 and provides the reception sensitivity based on the bit error rate. Even though the sensitivity is illustrated as being measured outside of the processor 100 in FIG. 2, in some embodiments, the sensitivity detector 400 is included in the processor 100. In some example embodiments, at least a portion of the sensitivity detector 400 is implemented in the form of program code or software that is executed by the processor 100.

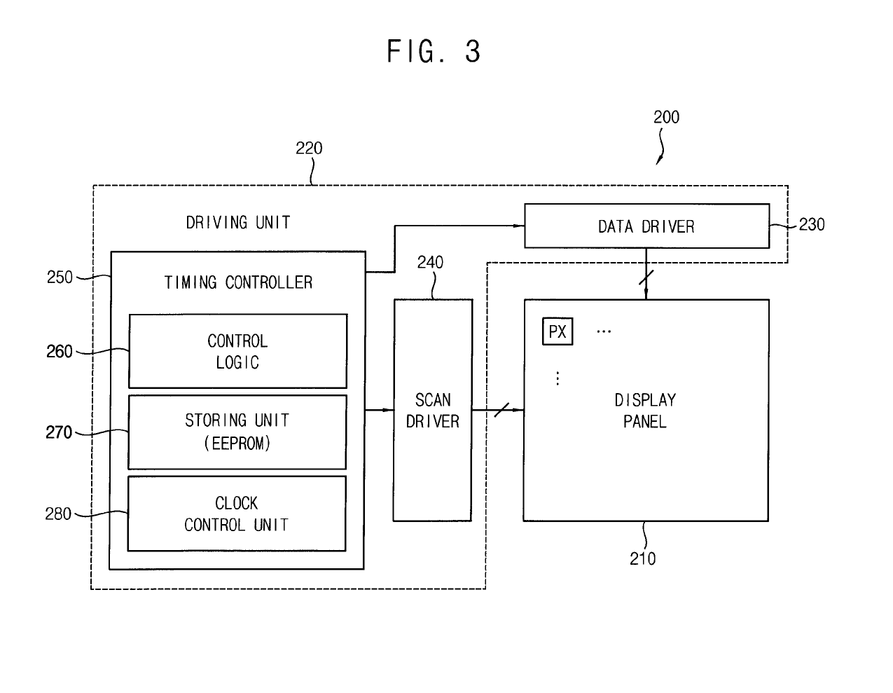

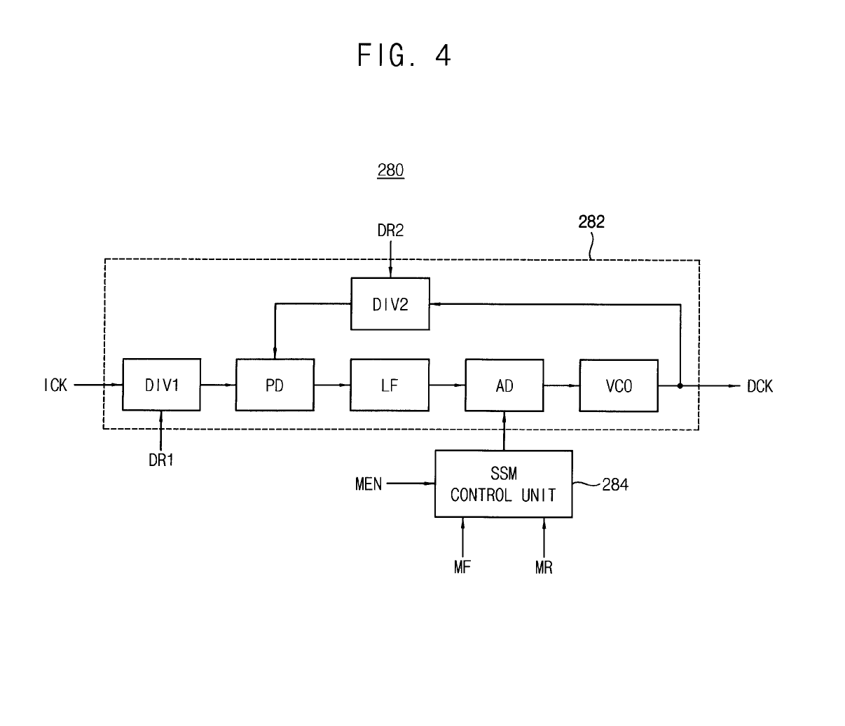

The display device 200 operates based on a driving clock signal DCK and store a clock control value CCV that controls the driving clock signal DCK. The display device 200 displays an image based on display data DDT received from the processor 100. The operation and configuration of the display device are further described with reference to FIGS. 3 and 4.

The processor 100 sequentially provides set values to change the clock control value CCV to the set values. The set values can be provided as set data SDT from the processor 100 to the display device 200. The processor 100 receives the reception sensitivities with respect to each of the set values from the sensitivity detector 400 and determines an optimal set value corresponding to a present wireless communication condition among the set values based on the reception sensitivities.

The processor 100 can be an application processor or a system on chip that includes an interconnection device and a plurality of operational units or processes. For example, the operational units can include a power management unit, a memory controller, a central processing unit, a display controller, a file system block, a graphic processing unit, an image signal processor, a multi-format codec block, etc.

FIG. 3 is a block diagram illustrating a display device included in the wireless communication apparatus of FIG. 2.

Referring to FIG. 3, the display device 200 includes a display panel 210 having a plurality of pixels PX and a driving unit 220 configured to drive the display panel 210. The driving unit 220 includes a data driver 230, a scan driver 240 and a timing controller 250.

The display panel 210 is connected to the data driver 230 through a plurality of data lines and is connected to the scan driver 240 through a plurality of scan lines. In some example embodiments, the display device 200 is an organic light-emitting diode (OLED) display, the driving unit 220 further includes an emission driver and the display panel 210 is further connected to the emission driver through a plurality of emission control lines. The pixels PX of the display panel 210 are located at the intersections between data lines and the scan lines.

The driving unit 220 can receive display data DDT from the processor 100 and drive the display panel 210 to display an image corresponding to the display data DDT. The driving unit 220 can drive the display panel 210 with a hybrid digital driving method. That is, the driving unit 220 can provide each pixel PX of the display panel 210 with a data voltage (e.g., a voltage for turning on a driving transistor or a voltage for turning off a driving transistor) that allows the driving transistor of the pixel PX to operate in a saturated region. The driving unit 220 can produce a grayscale luminance by adjusting the time duration for which the pixel PX emits light in each frame. Unlike the standard digital driving method in which the driving transistor of each pixel operates in a linear region, the display panel 210 can be driven with the hybrid digital driving method in which the driving transistor of each pixel PX operates in the saturated region, which increases the lifespan of the pixels PX.

The driving unit 220 includes the data driver 230, the scan driver 240 and the timing controller 250. The data driver 230 can apply a data voltage to the display panel 210 through the data lines. The scan driver 240 can apply a scan signal to the display panel 210 through the scan lines. In some example embodiments, the driving unit 220 further includes an emission driver that applies an emission control signal to the display panel 210 through a plurality of emission control lines.

The timing controller 250 can control the operations of the display device 200. For example, the timing controller 250 can provide control signals to the data driver 230 and the scan driver 240 to control the operations of the display device 200. In some example embodiments, the data driver 230, the scan driver 240 and the timing controller 250 can be implemented as a single integrated circuit (IC). In other example embodiments, the data driver 230, the scan driver 240 and the timing controller 250 can be implemented as two or more ICs.

The timing controller 250 includes a control logic or logic controller 260, a storing unit or memory 270 and a clock control unit or clock controller 280. The control logic 260 can control the overall operation of the timing controller 250. The storing unit 270 can be implemented with an electrically erasable programmable read-only memory (EEPROM) to store the above-described clock control value CCV. The control logic 260 can receive the set value and store the received set value in the storing unit 270 to replace the stored clock control value. The set values can be provided as the set data DDT from a processor 100 included in the wireless communication apparatus 10. The clock control unit 280 can control the driving clock signal DCK based on the clock control value CCV stored in the storing unit 270. In some example embodiments, the control logic 260, the storing unit 270 and the clock control unit 280 can be located in the timing controller 250 as illustrated in FIG. 3. In other example embodiments, at least one of the storing unit 270 and the clock control unit 280 can be located outside of the timing controller 250.

FIG. 4 is a block diagram illustrating a clock control unit included in the display device of FIG. 3.

Referring to FIG. 4, the clock control unit 280 includes a phase-locked loop 282 and a spread spectrum modulation (SSM) control unit or SSM controller 284.

The phase-locked loop 282 can receive an input clock signal ICK and output a driving clock signal DCK. The SSM control unit 284 can be enabled when a modulation enable signal MEN is activated and outputs a modulation voltage corresponding to a modulation frequency MF and a modulation rate MR when enabled.

The phase-locked loop 282 includes a phase detector PD, a loop filter LF, an adder AD, a voltage-controlled oscillator VCO, a first divider DIV1 and a second divider DIV2. The configuration of FIG. 4 is a non-limiting example and the phase-locked loop 282 may have various other configurations.

The first divider DIV1 can reduce the frequency of the input clock signal ICK based on a first division rate DR1 to provide a divided clock signal to the phase detector PD. The second divider DIV2 can reduce a frequency of the driving clock signal DCK based on a second division rate DR2 to provide another divided clock signal to the phase detector PD. According to example embodiments, the location and the number of the dividers can be changed. For example, the first divider DIV1 can be omitted and/or a third divider can be further included after the voltage-controlled oscillator VCO to reduce the frequency of the driving clock signal DCK.

The phase detector PD can detect a phase difference between the clock signals from the dividers DIV1 and DIV2 and output a phase-difference voltage proportional to the detected phase difference. The loop filter LF can filter the phase-difference voltage and output a filtered voltage. The loop filter LF can be a low-pass filter or an integrator circuit. The adder AD can add the modulation voltage from the SSM control unit 284 to the filtered voltage from the loop filter LF to provide the added voltage to the voltage-controlled oscillator VCO. The voltage-controlled oscillator VCO can generate the driving clock signal DCK based on the added voltage from the adder AD.

The SSM control unit 284 can be enabled when the modulation enable signal MEN is activated and can be disabled when the modulation enable signal MEN is deactivated. The clock control unit 280 can operate as a simple phase-locked loop (PLL) when the SSM control unit 284 is disabled and the clock control unit 280 can operate as a spread spectrum clock generator (SSCG) when the SSM control unit 284 is enabled.

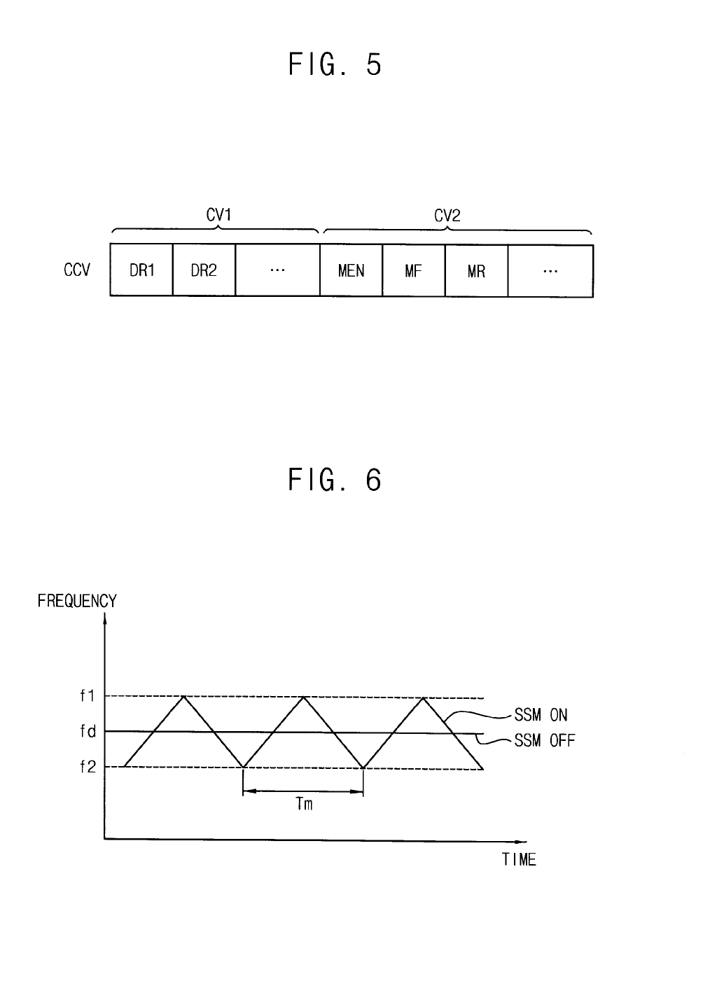

FIG. 5 is a diagram illustrating an example of a clock control value stored in a storing unit included in the display device.

Referring to FIG. 5, the clock control value CCV includes a first control value CV1 to control the frequency of the driving clock signal DCK and a second control value CV2 to control the spread spectrum modulation of the driving clock signal DCK.

For example, the first control value CV1 includes one or more division rates DR1 and DR2 which are provided to the phase-locked loop 282 as described with reference to FIG. 4. The frequency of the driving clock signal DCK can be adjusted by setting the division rates DR1 and DR2.

The second control value CV2 includes a flag value MEN indicating whether to perform the spread spectrum modulation. For example, the flag value MEN can be a value of one bit. The control logic 260 can refer to the flag value MEN stored in the storing unit 270 to generate the above-described modulation enable signal MEN. For example, the flag value of ‘0’ may indicate that the spread spectrum operation is performed (SSM ON) and the flag value of ‘1’ may indicate that the spread spectrum operation is not performed (SSM OFF). In contrast, the flag value of ‘1’ may indicate that the spread spectrum operation is performed (SSM ON) and the flag value of ‘0’ may indicate that the spread spectrum operation is not performed (SSM OFF).

The second control value CV2 further includes at least one of a modulation rate MR and a modulation frequency MF of the spread spectrum modulation, which are described with reference to FIG. 6.

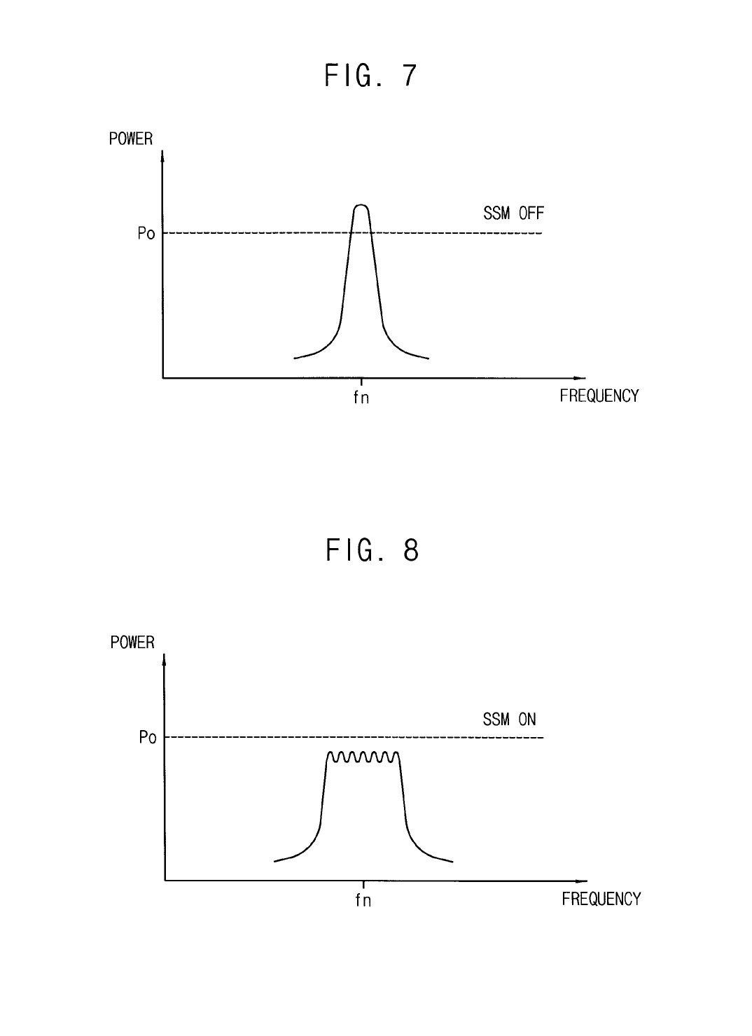

FIG. 6 is a diagram illustrating an example of a spread spectrum modulation and FIGS. 7 and 8 are diagrams for describing noise spreading according to spread spectrum modulation.

In some example embodiments, spread spectrum modulation SSM can be performed to modulate the frequency of the driving clock signal DCK as illustrated in FIG. 6. As described with reference to FIG. 4, when the SSM control unit 284 is disabled (OFF), the clock control unit 280 operates as a phase-locked loop and the frequency of the driving clock signal DCK can be maintained at a reference frequency fd. In contrast, when the SSM control unit 284 is enabled (ON), the clock control unit 280 operates as a spread spectrum clock generator and the frequency of the driving clock signal DCK is varied between a first frequency f1 and a second frequency f2 with a modulation period Tm.

In the example of FIG. 6, the modulation frequency MF corresponds to 1/Tm and the modulation rate MR corresponds to (f1−fd)/fd or (fd−f2)/fd. According to example embodiments, a decision of whether to perform or enable SSM can be determined to improve the reception sensitivity of the wireless communication apparatus. The reception sensitivity can be further improved by optimizing the modulation frequency MF and/or the modulation rate MR of the SSM. The modulation frequency MF and/or the modulation rate MR can be determined depending on operation characteristics of the clock control unit 280 and noise characteristics of the wireless communication channel.

When direct modulation as illustrated in FIG. 4 is adopted, the modulation frequency MF and the modulation rate MR can depend on the filtered voltage from the loop filter LF and the gain of the voltage-controlled oscillator VCO. The filtered voltage and the gain can be varied depending on manufacturing process, voltage and temperature (PVT) and thus the modulation frequency MF and the modulation rate MR can depend on the PVT. The effect of noise spreading may not be sufficient if the modulation frequency MF and the modulation rate MR are set to too small of values and the clock control unit 280 may be caused to malfunction if the modulation frequency MF and the modulation rate MR are set to too great of values.

FIG. 6 illustrates a non-limiting example of the SSM with a triangular waveform. In other embodiments, the waveform of the SSM is varied. For example, the SSM may have a sinusoidal waveform or an irregular waveform.

FIG. 7 illustrates a noise peak centered on a deep channel frequency fn when the SSM is disabled (OFF) and FIG. 8 illustrates a spread noise centered on the deep channel frequency fn when the SSM is enabled (ON). The deep channel frequency fn can correspond to a harmonic frequency of the driving clock signal DCK.

As illustrated in FIGS. 7 and 8, the SSM can be enabled when the peak noise power exceeds a reference power Po to reduce the noise power below the reference power Po. When the noise power is concentrated as illustrated in FIG. 7, the number of channels having insufficient reception sensitivity may be relative low but an irreversible error or problem may be caused. In contrast, when the noise power is spread as illustrated in FIG. 8, irrevocable errors or problems can be prevented but the number of poor channels may be increased.

According to example embodiments, whether to perform SSM can be determined and the parameters such as the modulation frequency and the modulation rate can be controlled by reflecting a change of wireless communication condition, that is, operational environments of the wireless communication apparatus, to reduce electro-magnetic interference due to the driving clock signal and improve the reception sensitivity of the wireless communication apparatus.

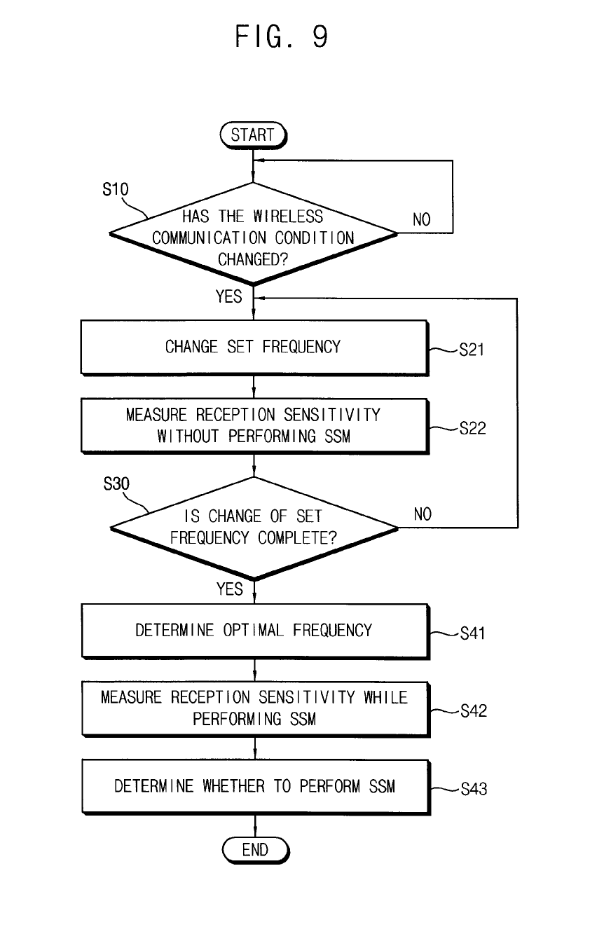

FIG. 9 is a flowchart illustrating a method of driving a display device according to an example embodiment.

Referring to FIGS. 2, 3, 4 and 9, the processor 100 can determine if wireless the communication condition is changed (S10). In some example embodiments, the processor 100 can monitor the reception sensitivity of the wireless communication apparatus 10 in real-time to determine if the wireless communication condition is changed. The reception sensitivity can be provided in real-time from the sensitivity detector 350. The processor 100 can determine whether to update the clock control value CCV stored in the storing unit 270 based on the monitoring results. In other example embodiments, the processor 100 can determine whether to update the clock control value CCV stored in the storing unit 270 based on a user's request, that is, an input operation of a user of the wireless communication apparatus.

When it is determined that the wireless communication condition is changed (S10: YES), the processor 100 can change the set frequency of the driving clock signal DCK (S21). For example, the set frequency can be changed such that the changed division rates DR1 and DR2 can be provided from the processor 100 to the display device 200 and the control logic 260 can store the received values in the storing unit 270.

The processor 100 can control the display device 200 and the sensitivity detector 350 to measure the reception sensitivity of the wireless communication apparatus 10 without performing spread spectrum modulation (SSM) (S22). As described above, the processor 100 can control whether SSM is performed by providing the flag value MEN to the display device 200.

The processor 100 can determine if change of the set frequency is completed (S30) and repeat changing the set frequency (S21) and measuring the reception sensitivity (S22) when the change of the set frequency is not completed (S30: NO). In some example embodiments, the number and values of the set frequency can be determined in advance through simulation, test operation, etc. The predetermined set frequencies can be stored and provided to the processor 100 in a form of a look-up table.

In some example embodiments, the processor 100 can continue change of the first control value CV1 stored in the storing unit 270 until the processor 100 obtains the reception sensitivities with respect to all of the predetermined set frequencies. In other example embodiments, the processor 100 can compare the reception sensitivity with a reference value whenever the reception sensitivity is measured with respect to each set frequency. The processor 100 can stop changing the set frequency when the measured reception sensitivity is greater than the reference value and determine the set frequency corresponding to the reception sensitivity greater than the reference value as an optimal frequency.

When the change of the set frequency is completed (S30: YES), the processor 100 cam determine the optimal frequency corresponding to the present wireless communication condition among the set frequencies based on the measured reception sensitivities (S41). The optimal frequency is provided to the display device 200 and stored in the storing unit 270. As described above, the optimal frequency can be stored as the division rates DR1 and DR2. The stored optimal frequency can be maintained until the update of the frequency of the driving clock signal DCK is required according to change of the wireless communication condition.

After the optimal frequency is determined, the processor 100 can control the display device 200 and the sensitivity detector 350 to measure the reception sensitivity corresponding to the optimal frequency while performing SSM (S42). The processor 100 can compare the reception sensitivity corresponding to the optimal frequency without performing spread spectrum modulation with the reception sensitivity corresponding to the optimal frequency while performing spread spectrum modulation. The processor 100 can determine wherein whether to perform SSM based on the comparison result (S43).

Even though not illustrated in FIG. 9, when it is determined to perform SSM, the processor can repeat changing the second control value CV2 and measuring the reception sensitivity to determine at least one of the modulation rate MR and the modulation frequency MF of the SSM corresponding to the present wireless communication condition, as described with reference to FIGS. 4 and 5.

As such, by monitoring the change of the wireless communication condition to control the driving clock signal DCK in real-time, the electro-magnetic interference due to the driving clock signal DCK can be reduced and the performance of the wireless communication apparatus can be improved.

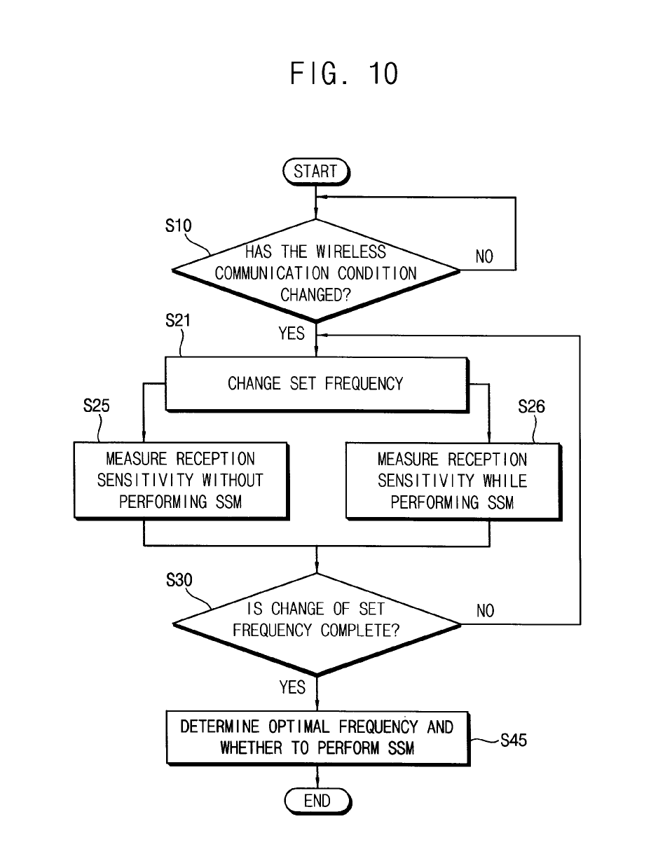

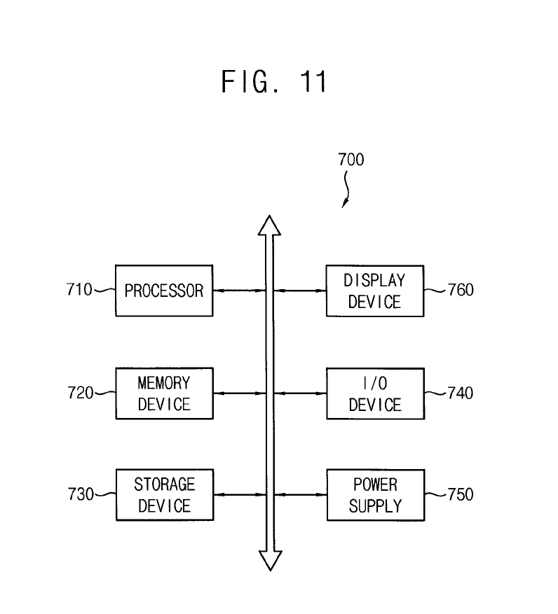

FIG. 10 is a flowchart illustrating a method of driving a display device according to another example embodiment.

Referring to FIGS. 2, 3, 4 and 10, the processor 100 can determine if the wireless communication condition is changed (S10). In some example embodiments, the processor 100 can monitor the reception sensitivity of the wireless communication apparatus 10 in real-time to determine if the wireless communication condition is changed. The reception sensitivity can be provided in real-time from the sensitivity detector 350. The processor 100 can determine whether to update the clock control value CCV stored in the storing unit 270 based on the monitoring results. In other example embodiments, the processor 100 can determine whether to update the clock control value CCV stored in the storing unit 270 based on a user's request, that is, an input operation of a user of the wireless communication apparatus.

When it is determined that the wireless communication condition is changed (S10: YES), the processor 100 can change a set frequency of the driving clock signal DCK (S21). For example, the set frequency can be changed such that the changed division rates DR1 and DR2 can be provided from the processor 100 to the display device 200, and the control logic 260 can store the received values in the storing unit 270.

The processor 100 can control the display device 200 and the sensitivity detector 350 to measure the reception sensitivity of the wireless communication apparatus 10 without performing spread spectrum modulation (SSM) (S25). In addition, the processor 100 can control the display device 200 and the sensitivity detector 350 to measure the reception sensitivity of the wireless communication apparatus 10 while performing SSM (S26). As described above, the processor 100 can control whether SSM is performed by providing the flag value MEN to the display device 200.

The processor 100 can determine if change of the set frequency is completed (S30) and repeat changing the set frequency (S21) and measuring the reception sensitivity (S25, S26) when the change of the set frequency is not completed (S30: NO). In some example embodiments, the number and values of the set frequency can be determined in advance through simulation, test operation, etc. The predetermined set frequencies can be stored and provided to the processor 100 in the form of a look-up table.

In some example embodiments, the processor 100 can continue change of the first control value CV1 stored in the storing unit 270 until the processor 100 obtains the reception sensitivities with respect to all of the predetermined set frequencies. In other example embodiments, the processor 100 can compare the reception sensitivity with a reference value whenever the reception sensitivity is measured with respect to each set frequency. The processor 100 can stop changing the set frequency when the measured reception sensitivity is greater than the reference value and determine the set frequency corresponding to the reception sensitivity greater than the reference value as an optimal frequency.

When the change of the set frequency is completed (S30: YES), the processor 100 can determine an optimal frequency corresponding to the present wireless communication condition among the set frequencies and whether to perform SSM (S45) based on the measured reception sensitivities.

As such, by monitoring the change of the wireless communication condition to control the driving clock signal DCK in real-time, the electro-magnetic interference due to the driving clock signal DCK can be reduced and the performance of the wireless communication apparatus can be improved.

FIG. 11 is a block diagram illustrating a wireless communication apparatus according to example embodiments.

Referring to FIG. 11, the wireless communication apparatus 700 includes a processor 710, a memory device 720, a storage device 730, an input/output (I/O) device 740, a power supply 750, and a display device 760. The wireless communication apparatus 700 may further include a plurality of ports for communicating with a video card, a sound card, a memory card, a universal serial bus (USB) device, or other electronic systems.

The processor 710 can perform various computing functions or tasks. The processor 710 can be for example, a microprocessor, a central processing unit (CPU), etc. The processor 710 can be connected to other components via an address bus, a control bus, a data bus, etc. Further, the processor 710 can be connected to an extended bus such as a peripheral component interconnection (PCI) bus.

The memory device 720 can store data for operation of the wireless communication apparatus 700. For example, the memory device 720 can include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and/or at least one volatile memory device such as a dynamic random access memory (DRAM) device, a static random access memory (SRAM) device, a mobile dynamic random access memory (mobile DRAM) device, etc.

The storage device 730 can be, for example, a solid state drive (SSD) device, a hard disk drive (HDD) device, a CD-ROM device, etc. The I/O device 740 may be, for example, an input device such as a keyboard, a keypad, a mouse, a touch screen, and/or an output device such as a printer, a speaker, etc. The power supply 750 can supply power for operations of the wireless communication apparatus 700. The display device 760 can communicate with other components via the buses or other communication links.

As described above, the display device 760 can operate based on the driving clock signal DCK and store the clock control value CCV to control the driving clock signal DCK. The processor 710 can sequentially provide set values to change the clock control value CCV to the set values. The set values can be provided as set data SDT from the processor 710 to the display device 760. The processor 710 can receive the reception sensitivities with respect to each of the set values from the sensitivity detector and determine the optimal set value corresponding to the present wireless communication condition among the set values based on the reception sensitivities.

According to at least one example embodiment, electro-magnetic interference due to the driving clock signal of the display device can be reduced and the reception sensitivity can be improved by adaptively controlling the driving clock signal based on the change of the wireless communication condition. Through the adaptive control of the driving control signal, the display panel of the same specification can be adopted regardless of its states, telecommunication companies, communication standards, etc. The debugging process, which is required in designing the processor and/or the display device of the wireless communication apparatus, can be automated through the adaptive control of the driving clock signal. The cost and time for developing the wireless communication apparatus can be reduced and thus productivity can be improved.

The example embodiments can be applied to any wireless communication apparatus 700 having an organic light-emitting diode display device 760. For example, the present embodiments can be applied to a wireless communication apparatus 700 such as a television, a computer monitor, a laptop, a digital camera, a cellular phone, a smart phone, a personal digital assistant (PDA), a portable multimedia player (PMP), an MP3 player, a navigation system, a video phone, etc.

The foregoing is illustrative of example embodiments and is not to be construed as limiting thereof. Although a number of example embodiments have been described, those skilled in the art will readily appreciate that many modifications are possible in the example embodiments without materially departing from the novel teachings and advantages of the present inventive technology. Accordingly, all such modifications are intended to be included within the scope of the invention as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of driving a display device included in a wireless communication apparatus, the method comprising:
sequentially changing a clock control value to a plurality of predetermined set values, wherein the clock control value is stored in a memory and is configured to control a driving clock signal of the display device;
measuring a plurality of reception sensitivities of the wireless communication apparatus with respect to each of the set values;
determining an optimal one of the set values corresponding to a present wireless communication condition based on the measured reception sensitivities; and
storing the optimal set value in the memory as the clock control value.

2. The method of claim 1, wherein the clock control value includes a first control value configured to control a frequency of the driving clock signal and a second control value configured to control a spread spectrum modulation of the driving clock signal.

3. The method of claim 2, wherein the first control value includes at least one division rate and wherein the display device includes a phase-locked loop configured to generate the driving clock signal based on the division rate.

4. The method of claim 2, wherein the second control value includes a flag value indicating whether to perform the spread spectrum modulation.

5. The method of claim 4, wherein the second control value further includes at least one of a modulation rate and a modulation frequency of the spread spectrum modulation.

6. The method of claim 1, wherein sequentially changing the clock control value includes:
receiving each of the set values from a processor included in the wireless communication apparatus; and
sequentially storing each of the received set values in the memory to replace the clock control value stored in the memory.

7. The method of claim 1, wherein the memory is an electrically erasable and programmable read only memory (EEPROM).

8. The method of claim 1, further comprising:
sequentially changing a frequency of the driving clock signal to a plurality of set frequencies;
measuring the reception sensitivities with respect to each of the set frequencies without performing the spread spectrum modulation; and
determining an optimal one of the set frequencies corresponding to the present wireless communication condition based on the measured reception sensitivities.

9. The method of claim 8, further comprising:
measuring the reception sensitivity corresponding to the optimal frequency while performing the spread spectrum modulation;
comparing the measured reception sensitivity corresponding to the optimal frequency without performing the spread spectrum modulation to the reception sensitivity corresponding to the optimal frequency measured while performing the spread spectrum modulation; and
determining whether to perform the spread spectrum modulation based on the comparison result.

10. The method of claim 9, further comprising:
when it is determined to perform the spread spectrum modulation, determining at least one of a modulation rate and a modulation frequency of the spread spectrum modulation corresponding to the present wireless communication condition.

11. The method of claim 1, further comprising:
sequentially changing a frequency of the driving clock signal to a plurality of set frequencies;
measuring the reception sensitivities with respect to each of the set frequencies without performing the spread spectrum modulation; and
measuring the reception sensitivities with respect to each of the set frequencies while performing the spread spectrum modulation.

12. The method of claim 11, further comprising:
determining an optimal one of the set frequencies corresponding to the present wireless communication condition; and
determining whether to perform the spread spectrum modulation based on the measured reception sensitivities.

13. The method of claim 1, further comprising:
monitoring the reception sensitivities of the wireless communication apparatus in real-time; and
determining whether to update the clock control value stored in the memory based on the monitoring results.

14. The method of claim 1, further comprising:
determining whether to update the clock control value stored in the storing unit based on an input operation of a user of the wireless communication apparatus.

15. The method of claim 1, wherein the reception sensitivity is measured as a bit error rate of a wireless signal received by the wireless communication apparatus.

16. A wireless communication apparatus comprising:
a sensitivity detector configured to measure a plurality of reception sensitivities of a wireless signal with respect to a plurality of set values;
a display device configured to operate based on a driving clock signal and store a clock control value configured to control the driving clock signal; and
a processor configured to: i) sequentially provide the set values to the display device so as to change the clock control value to the set values, ii) receive the reception sensitivities from the sensitivity detector, and iii) determine an optimal one of the set values corresponding to a present wireless communication condition based on the reception sensitivities.

17. The wireless communication apparatus of claim 16, wherein the clock control value includes a first control value configured to control a frequency of the driving clock signal and a second control value configured to control a spread spectrum modulation of the driving clock signal.

18. The wireless communication apparatus of claim 16, wherein the display device comprises:
an electrically erasable and programmable read only memory (EEPROM) configured to store the clock control value; and
a clock controller configured to control the driving clock signal based on the clock control value stored in the EEPROM.

19. The wireless communication apparatus of claim 16, wherein the processor is further configured to:
monitor the reception sensitivities of the wireless communication apparatus in real-time; and
determine whether to update the clock control value stored in the memory based on the monitoring results.

20. The wireless communication apparatus of claim 16, wherein the processor is further configured to determine whether to update the clock control value stored in the memory based on an input operation of a user of the wireless communication apparatus.
